(19) United States
(12) Patent Application Publication
(10) Pub. No.: US 2013/0201384 A1
(43) Pub. Date: Aug. 8, 2013

(54) LIQUID LENS AND APPARATUS INCLUDING THE SAME

(71) Applicant: Minoru Tsuji, Utsunomiya-shi (JP)

(72) Inventor: Minoru Tsuji, Utsunomiya-shi (JP)

(73) Assignee: CANON KABUSHIKI KAISHA, Tokyo (JP)

(21) Appl. No.: 13/878,547

(22) PCT Filed: Sep. 26, 2011
(86) PCT No.: PCT/JP2011/072707

§ 371 Date: Apr. 9, 2013

(30) Foreign Application Priority Data
Oct. 12, 2010 (JP) 2010-229655

(51) Int. Cl. G02B 3/14

(52) U.S. Cl. CPC G02B 3/14
USPC 348/345; 359/666

(57) ABSTRACT

A decrease in the spectral transmittance of a liquid lens due to yellowing of an iodide aqueous solution used as an electrolytic solution is inhibited. A liquid lens includes a liquid container, an electrolytic solution contained in the container and containing iodide ions and a water-soluble antioxidant that inhibits oxidation of the iodide ions, a nonelectrolytic solution contained in the container and forming an interface with the electrolytic solution, and an electrode configured to apply a voltage to the electrolytic solution. A voltage is applied across the electrolytic solution and the electrode to change the curvature of the interface.

### TECHNICAL FIELD

The present invention relates to liquid lenses including an electrolytic solution containing iodide ions and apparatuses including such liquid lenses.

### BACKGROUND ART

Recently, research and development has been conducted on liquid lenses as a type of lens with variable refractive power.

Among several types of liquid lenses is one based on electrowetting (EW), which changes the angle between an interface between two liquids, namely, an electrolytic solution and a nonelectrolytic solution, and a solid part in contact with the two liquids (hereinafter also referred to as “contact angle”) as a voltage is applied across the electrolytic solution and an electrode.

Liquid lenses based on EW (hereinafter referred to as “EW liquid lenses”) are currently most promising because they operate quickly, have an interface with high surface precision, are compact, and reduce the number of parts for cost reduction.

An EW liquid lens includes an electrolytic (conductive) solution and a nonelectrolytic (nonconductive) solution having different refractive indices and adjusted to similar specific gravities. These two solutions are sealed in a container to form an interface without mixing with each other.

In the sealed state, a voltage applied across the electrolytic solution and an electrode layer disposed with an insulating layer therebetween changes the contact angle at the end of the interface between the two liquids without changing the volumes thereof. As the contact angle changes, the radius of curvature of the spherical interface changes correspondingly. This changes optical refractive power because of the difference in refractive index between the two liquids.

As an example of an EW liquid lens, PTL 1 discloses a liquid lens including an electrolytic solution containing a bromide salt such as lithium bromide or sodium bromide.

PTL 2, on the other hand, discloses that an electrolytic solution containing anions such as halide ions (e.g., chloride, bromide, or iodide ions), sulfate ions, or carbonate ions can be used.

A study conducted by the inventor has revealed that an electrolytic solution containing a bromide salt, such as the one disclosed in PTL 1, can be adjusted over a certain range of specific gravity, but is unsuitable for adjustment over a relatively wide range of specific gravity.

On the other hand, the inventor has realized that an electrolytic solution containing iodide ions, such as the one disclosed in PTL 2, provides the following advantage. That is, the electrolytic solution can be adjusted over a wide range of specific gravity because the iodide ions are produced by dissolving an iodide, which has a higher water solubility than other halides. Thus, the electrolytic solution can be adjusted to a specific gravity similar to that of a nonelectrolytic solution having high refractive index and high specific gravity. This allows various liquid lenses to be configured.

However, it has turned out that the iodide ions contained in the electrolytic solution (iodide aqueous solution having an iodide dissolved therein) are oxidized to form triiodide ions when irradiated with, for example, ultraviolet radiation. This causes a problem in that the triiodide ions yellow the electrolytic solution, thus decreasing spectral transmittance.

### CITATION LIST

### Patent Literature

PTL 1 International Patent Publication No. WO 2007-088452

PTL 2 International Patent Publication No. WO 2007-088453

### SUMMARY OF INVENTION

The present invention provides an liquid lens that allows adjustment over a wide range of specific gravity to support nonelectrolytic solutions having various refractive indices and that maintains its spectral transmittance over an extended period of time.

According to an aspect of the present invention, there is provided a liquid lens including a liquid container, an electrolytic solution contained in the container and containing iodide ions and a water-soluble antioxidant that inhibits oxidation of the iodide ions, a nonelectrolytic solution contained in the container and forming an interface with the electrolytic solution, and an electrode configured to apply a voltage to the electrolytic solution. A voltage is applied across the electrolytic solution and the electrode to change the curvature of the interface.

In the liquid lens according to the above aspect, the electrolytic solution contains iodide ions and a water-soluble antioxidant that inhibits oxidation of iodide ions. The water-soluble antioxidant contained in the electrolytic solution inhibits oxidation of the iodide ions. This inhibits formation of triiodide ions, which yellow the electrolytic solution, so that the liquid lens maintains its spectral transmittance, thus providing stable performance over an extended period of time. In addition, the electrolytic solution can be adjusted over a relatively wide range of specific gravity because the iodide ions contained therein are produced by dissolving an iodide, which has a higher water solubility than other halides. Thus, the electrolytic solution can be adjusted to a specific gravity similar to those of nonelectrolytic solutions having various refractive indices. This allows various liquid lenses to be configured.

### BRIEF DESCRIPTION OF DRAWINGS

FIG. 1 is a schematic sectional view of a liquid lens according to an embodiment of the present invention.

FIG. 2 is a graph showing the relationship between antioxidant concentration and spectral transmittance.

FIG. 3 is a schematic diagram of an image pickup apparatus having an optical system including a liquid lens according to an embodiment of the present invention.

FIG. 4 is a schematic diagram of an optical unit including a liquid lens according to an embodiment of the present invention and a solid lens.

FIG. 5 is a block diagram of a relevant part of a digital camera including a liquid lens according to an embodiment of the present invention.

FIG. 6 is a schematic diagram of a relevant part of a cellular phone including a liquid lens according to an embodiment of the present invention.

FIG. 7A is a schematic illustration of a surveillance camera including a liquid lens according to an embodiment of the present invention.

FIG. 7B is a block diagram of a surveillance camera system.

### DESCRIPTION OF EMBODIMENTS

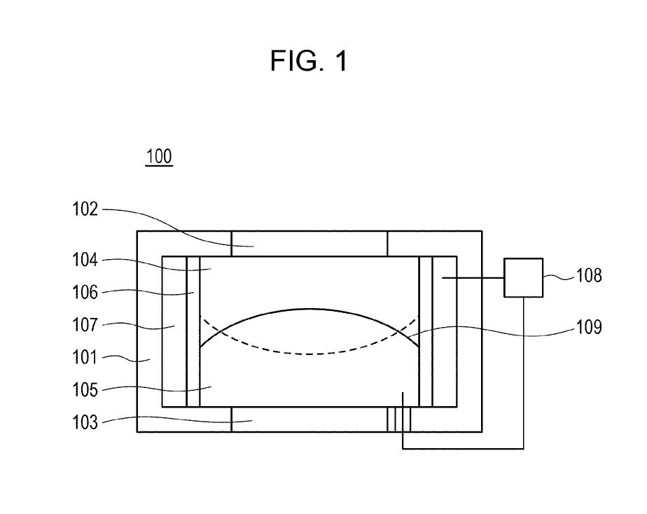

Embodiments of the present invention will now be described with reference to the drawings. FIG. 1 is a schematic diagram of a liquid lens, according to an embodiment of the present invention, including a cylindrical container serving as a liquid container. This figure is a sectional view taken along a plane including the central axis (optical axis) of the cylindrical container.

In FIG. 1, a liquid lens 100 includes a cylindrical container composed of a cylindrical member 101 and transparent lids 102 and 103 bonded to either end of the cylindrical member 101. The cylindrical container contains a first liquid 104 (nonelectrolytic solution) and a second liquid 105 (electrolytic solution) that are adjacent to each other. The first liquid 104 is an insulating transparent liquid, whereas the second liquid 105 is a conductive transparent liquid. The two liquids 104 and 105 are immiscible with each other and have different refractive indices.

The first liquid 104 can be, for example, silicone oil or a mixture of liquid paraffin, 1-bromonaphthalene, and diiodomethane. The second liquid 105 is an aqueous solution serving as an electrolytic solution containing iodide ions, which constitutes a feature of this embodiment. The second liquid 105 will be described in more detail later.

An annular electrode 107 is formed on the inner wall of the cylindrical member 101. The two liquids 104 and 105 are adjacent to the electrode 107 with an insulator 106 therebetween. A voltage source 108 applies a voltage across the second liquid 105 and the electrode 107 to cause EW, which changes the interface between the two liquids 104 and 105 from an interface 109 indicated by the solid line to an interface indicated by the dotted line.

Liquid lenses use liquids having little difference in specific gravity to form an interface with high surface precision that functions as an optical surface. In this embodiment, for example, if the first liquid 104, serving as a nonelectrolytic solution, is a mixture of liquid paraffin, 1-bromonaphthalene, and diiodomethane with a specific gravity of 1.58, the specific gravity of the second liquid 105, serving as an electrolytic solution, is increased to around 1.58, for example, by adding an additive.

As a feature of this embodiment, the electrolytic solution contains iodide ions, which are produced from an iodide dissolved in the electrolytic solution. Examples of solvents used for the electrolytic solution include water, which is most common, and polar solvents such as alcohols and acetone.

An iodide, which has a higher water solubility than other halides, can be dissolved in water to adjust the aqueous solution over a wide range of specific gravity. For example, a sodium bromide aqueous solution can have a specific gravity of about 1.0 to 1.4, whereas a sodium iodide aqueous solution can have a specific gravity of about 1.0 to 1.8.

Examples of iodides that allow adjustment of the aqueous solution over a wide range of specific gravity include potassium iodide, sodium iodide, magnesium iodide, and zinc iodide.

A sodium iodide aqueous solution will now be taken as an example of the second liquid 105. Because silicone oil, serving as the first liquid 104, has a specific gravity of 1.58, the sodium iodide aqueous solution is adjusted to a specific gravity of about 1.58. In this case, the mass concentration of sodium iodide in the sodium iodide aqueous solution is about 50%.

In an aqueous solution containing iodide ions, the iodide ions undergo the oxidation reaction represented by formula 1 under the effect of, for example, ultraviolet radiation contained in sunlight to form iodine:

2I⁻→I₂+2e⁻ (1)

In addition, the iodine formed in formula 1 undergoes the equilibrium reaction represented by formula 2 with the iodide ions in the aqueous solution to form triiodide ions:

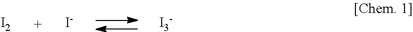

As described above, an aqueous solution containing triiodide ions has the problem of decreasing the spectral transmittance of a liquid lens because the solution looks yellow at low concentrations and brown at high concentrations.

To solve this problem, in this embodiment, the second liquid 105, serving as an electrolytic solution, contains a water-soluble antioxidant in addition to iodide ions.

A water-soluble antioxidant is used in this embodiment because it is highly soluble in a polar solvent such as water, which is typically used as a solvent of an electrolytic solution, thus sufficiently providing its function as an antioxidant when dissolved in a solvent. Hence, antioxidants used in this embodiment exclude antioxidants almost insoluble in water, such as dibutylhydroxytoluene (BHT) and butylhydroxyanisole (BHA).

The water-soluble antioxidant contained in the second liquid 105 inhibits the oxidation reaction of iodide ions represented by formula 1. This inhibits formation of triiodide ions, which are the product of the equilibrium reaction represented by formula 2, thus inhibiting yellowing of the second liquid 105 and therefore a decrease in the spectral transmittance of the liquid lens 100.

The oxidation reaction of iodide ions described above can be inhibited using an antioxidant having a standard redox potential of 0.53 V or less because iodine has a standard redox potential of about 0.53 V.

The antioxidant will now be described by introducing an experiment conducted for attaining this embodiment.

### Experiment and Antioxidant

Table 1 shows the compositions of eight samples, namely, A, B, C, D, E, F, G, and H, prepared and used for examining the effect of the antioxidant in this embodiment.

TABLE 1

| | Liquid sample | | | | | | | |
|---|---|---|---|---|---|---|---|---|
| Constituent | A | B | C | D | E | F | G | H |
| Ultrapure water | 5 g | 5 g | 5 g | 5 g | 5 g | 5 g | 5 g | 5 g |
| Sodium iodide | 5 g | 5 g | 5 g | 5 g | 5 g | 5 g | 5 g | 5 g |
| Ascorbic acid | 0 mg | 0.1 mg | 0.2 mg | 0.25 mg | 0.3 mg | 0.4 mg | 0.5 mg | 1.0 mg |
| Mass concentration of | 0.000% | 0.001% | 0.002% | 0.0025% | 0.003% | 0.004% | 0.005% | 0.010% |
| ascorbic acid in iodide | | | | | | | | |
| aqueous solution | | | | | | | | |

In this experiment, an aqueous solution containing iodide ions was prepared by dissolving sodium iodide in ultrapure water, and the eight samples were prepared by dissolving different amounts of ascorbic acid, which has a standard redox potential of 0.36 V, as an antioxidant in the aqueous solution.

Each sample was put in a 10 mL beaker, was irradiated with ultraviolet radiation having a wavelength of 375 nm for a predetermined period of time, and was examined for spectral transmittance. The spectral transmittance was examined by filling a glass cell having a path length of 10 mm with each sample, making light having varying wavelengths in the ultraviolet to visible region incident on the glass cell at an incident angle of 90°, and measuring the intensity ratio of the transmitted light to the incident light.

The spectral transmittances of the eight samples shown below are the spectral transmittances measured by the method described above and normalized by the spectral transmittance of ultrapure water measured by the same method.

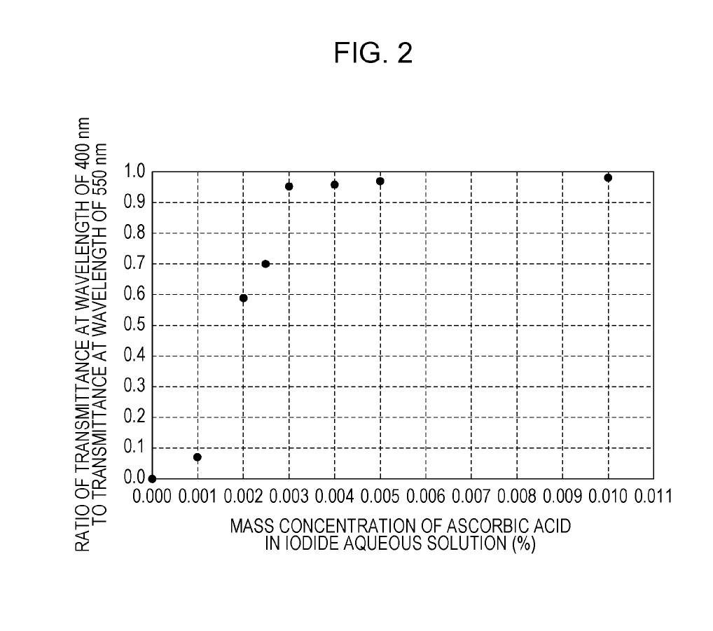

FIG. 2 is a graph showing the relationship between the mass concentration (%) of the antioxidant contained in the samples and the ratio of the transmittance at a wavelength of 400 nm to the transmittance at a wavelength of 550 nm (hereinafter referred to as “T400/550”). In this experiment, T400/550 was used as a measure of how much each sample yellowed, and samples having a T400/550 of less than 0.7 were determined to be yellowed.

As can be seen from FIG. 2, the samples having an antioxidant mass concentration of 0.002% or less had a T400/550 of less than 0.7, which indicates that the samples yellowed.

In contrast, the sample having an antioxidant mass concentration of 0.0025% to less than 0.003% had a T400/550 of 0.7 or more, which indicates that the antioxidant inhibited the sample from yellowing.

Furthermore, the samples having an antioxidant mass concentration of 0.003% or more had a T400/550 of 0.95 or more, which indicates that the antioxidant further inhibited the samples from yellowing.

As is obvious from the fact that an iodide aqueous solution having a higher antioxidant mass concentration had a higher T400/550, as shown in FIG. 2, the advantages of this embodiment are not lowered even if the iodide aqueous solution contains excess antioxidant.

The mass concentrations of sodium iodide in Samples A, B, C, D, E, F, G, and H were 50% after they were adjusted to a specific gravity of about 1.58 because the first liquid 104 has a specific gravity of 1.58. Iodide aqueous solutions having an iodide mass concentration of 50% or less, including Samples B, C, D, E, F, G, and H, can be inhibited from yellowing by dissolving the antioxidant in an amount within the above range of mass concentration.

On the other hand, iodide aqueous solutions having an iodide mass concentration of more than 50% can be inhibited from yellowing by dissolving the antioxidant in an amount more than the above range of mass concentration.

Whereas the antioxidant used for the samples was ascorbic acid, which has a standard redox potential of 0.36 V, the above effect can also be provided using an antioxidant having a standard redox potential of 0.36 V or less.

Examples of antioxidants having a standard redox potential of 0.36 V or less include glucose, lactic acid, malic acid, fumaric acid, ubiquinone, pyruvic acid, and carbonyl reductase, which can be used as the antioxidant alone or in combination.

In general, iodide ions in an iodide aqueous solution are oxidized after extended exposure to light containing ultraviolet radiation, such as light from fluorescent lamps or sunlight. The aqueous solution then yellows, depending on the concentration of the iodide in the aqueous solution, thus decreasing the spectral transmittance of the aqueous solution. In this embodiment, the decrease in spectral transmittance is inhibited by dissolving an antioxidant in the electrolytic solution.

The antioxidant used in this embodiment can be one that prevents the electrolytic solution (aqueous solution) from yellowing when dissolved in the aqueous solution. Specifically, an antioxidant that allows an aqueous solution containing the antioxidant to have a T400/550 of 0.7 or more can be selected.

In particular, an antioxidant that forms a water-soluble oxide can be used in this embodiment so that it does not affect the optical properties of the liquid lens 100, for example, does not form an oxide precipitate that blocks the optical path of the liquid lens 100. In addition, an antioxidant that does not form an oxide that yellows the aqueous solution when dissolved therein can be used.

From these viewpoints, examples of antioxidants that can be used in this embodiment include ascorbic acid, erythorbic acid, and sodium erythorbate.

The second liquid 105 can contain other substances that do not impair the effect of the antioxidant. For example, the second liquid 105 can contain a freezing-point depressor such as ethylene glycol, a viscosity modifier such as ethanol, and a biocide such as ammonium bromide.

### OTHER EMBODIMENTS

In the liquid lens 100 according to this embodiment, either an AC voltage or a DC voltage can be applied across the second liquid 105 and the electrode 107. In particular, an AC voltage can be applied in view of reducing charge-up on the surface of the insulator 106.

The liquid lens 100 according to this embodiment does not necessarily have to be equipped with a dedicated voltage source (108 in FIG. 1) if it is applied to an optical apparatus such as a digital camera, a camcorder, a camera-equipped cellular phone, or a surveillance camera because the power supply of the optical apparatus can be used as the voltage source.

To prevent a short-circuit through the cylindrical member 101 when a voltage is applied across the second liquid 105 and the electrode 107 in FIG. 1, an electrically insulating member is used as the cylindrical member 101. Alternatively, an electrically insulating member can be disposed on the inner wall surface of a conductive cylindrical member 101.

In addition, the electrode 107 can be configured such that it also serves as the cylindrical member 101. In this case, the electrode 107 needs to be configured such that no short-circuit occurs between the second liquid 105 and the electrode 107. For example, the insulator 106 can also be provided on the portion of the inner wall surface of the electrode 107 in contact with the second liquid 105.

The liquid lens 100 is configured such that external light enters through the lids 102 and 103, which, therefore, are formed of a transparent material such as glass or acrylic resin.

An example of an application of a liquid lens according to an embodiment of the present invention to an optical system of an image pickup apparatus will now be described.

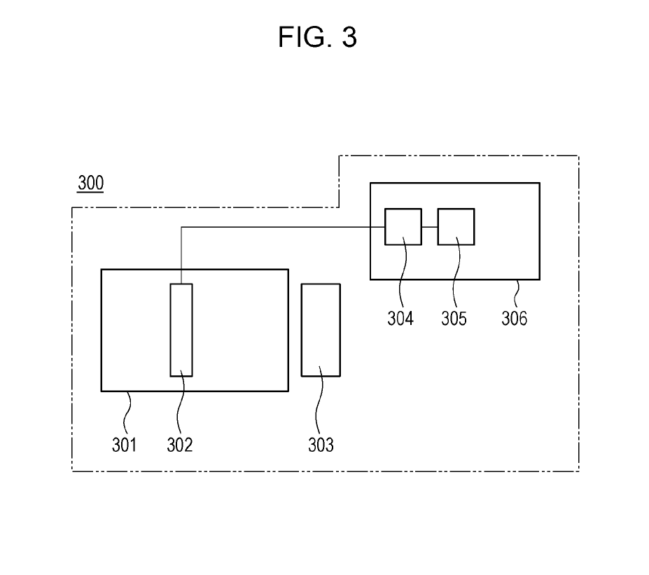

FIG. 3 is a schematic diagram of an image pickup apparatus 300 having an optical system 301 including a liquid lens 302 according to an embodiment of the present invention.

In addition to the liquid lens 302, the optical system 301 can include other optical elements such as a solid lens, an aperture stop, and a low-pass filter. An image pickup device 303 can be, for example, a charge-coupled device (CCD) sensor or a complementary metal-oxide-semiconductor (CMOS) sensor.

A control unit 306 generates the voltage applied to the liquid lens 302. The control unit 306 includes a driver 304 that outputs a voltage and a controller 305 that calculates the voltage to be output. The controller 305 receives a signal requesting that the curvature of the interface of the liquid lens 302 be changed to a predetermined value from, for example, a focus sensor mounted on the image pickup apparatus 300 or the user handling the image pickup apparatus 300, and transmits a signal indicating the calculated voltage to be applied to the driver 304. The driver 304 then applies the voltage based on the signal received from the controller 305 to the liquid lens 302.

As the curvature of the liquid lens 302 is changed (that is, the refractive power of the liquid lens 302 is changed), the refractive power of the optical system 301 is changed, and accordingly the position of the focal plane is changed. The liquid lens 302 adjusts the position of the focal plane of an object to be imaged to the position of an image pickup surface of the image pickup device 303, thus providing an autofocus or zoom function.

The optical system 301 can include at least one liquid lens 302 to provide the above autofocus or zoom function using the liquid lens 302.

Apart from liquid lenses, an embodiment of the present invention can also be applied to a variable neutral density (ND) filter or an apodization filter disclosed in Japanese Patent Laid-Open No. 2000-356792.

The present invention will now be described in more detail with reference to the examples below.

### EXAMPLES

### Example 1

An example of a liquid lens according to an embodiment of the present invention integrated with another optical element and a semiconductor device into one unit will be described.

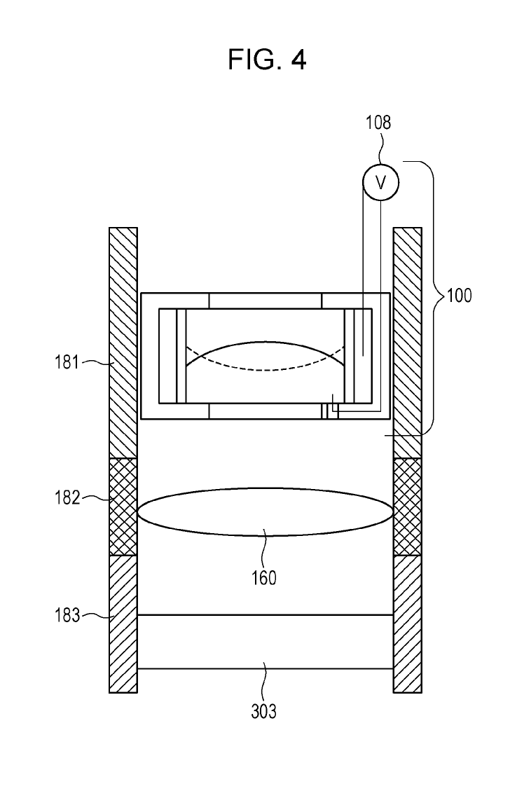

FIG. 4 shows an example of an liquid lens 101 according to an embodiment of the present invention integrated with a solid lens 160, such as a glass lens, and an image pickup device 303, such as a CMOS sensor or CCD sensor, into one unit using holders 181, 182, and 183.

Various modifications are permitted; for example, it is possible to use a plurality of solid lenses 160, to interchange the positions of the liquid lens 100 and the solid lens 160, or to dispose the liquid lens 100 between a plurality of solid lenses 160. In addition, whereas the liquid lens 100, the solid lens 160, and the image pickup device 303 are integrated into one unit in FIG. 4, it is also possible to integrate only the liquid lens 100 and the solid lens 160 into one unit (lens unit), or to integrate a liquid lens 100 that needs no solid lens and the image pickup device 303 into one unit. Alternatively, it is possible to integrate the liquid lens 100 and the holder 181 into one unit and incorporate it into the front of a camera unit including a solid lens and an image pickup device.

It is also possible to combine the liquid lens 100 and a plurality of solid lenses 160 into a zoom lens.

The liquid lens 100 allows adjustment over a wide range of specific gravity and can be configured to have a large difference in refractive index by adjusting the electrolytic solution to a specific gravity similar to that of an oil (nonelectrolytic solution) having high specific gravity and high refractive index. That is, because the liquid lens 100 has high power, it can provide predetermined power with a smaller change in the curvature of the interface, thus requiring a smaller size.

The liquid lens 100 can be integrated with a member having another function to configure a compact unit having a plurality of functions.

### Example 2

An example of an application of a liquid lens according to an embodiment of the present invention to a digital camera will be described.

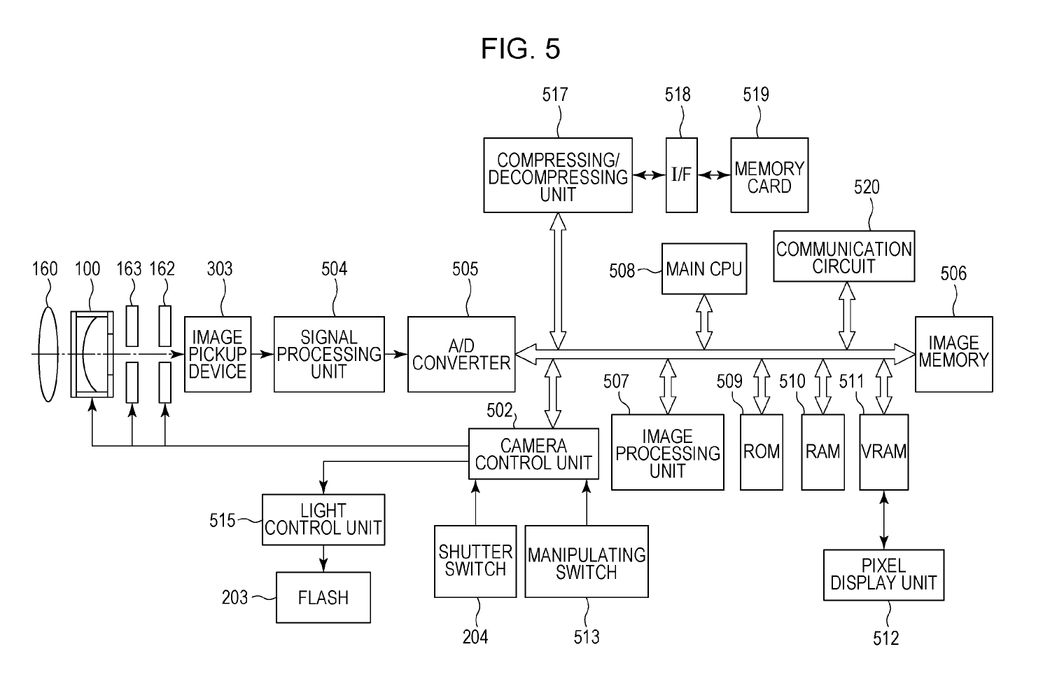

FIG. 5 is a block diagram of a relevant part of a digital camera. The digital camera in FIG. 5 uses a liquid lens 100 according to an embodiment of the present invention in combination with a solid lens 160. Light passing through the solid lens 160 and the liquid lens 100 forms an image on an image pickup device 303 through an aperture stop 163 and a shutter 162.

The liquid lens 100, the aperture stop 163, and the shutter 162 are controlled by a control signal from a camera control unit 502.

A feature of this digital camera is that it includes the liquid lens 100. The liquid lens 100 allows adjustment over a wide range of specific gravity and can be configured to have a large difference in refractive index by adjusting the electrolytic solution to a specific gravity similar to that of an oil (nonelectrolytic solution) having high specific gravity and high refractive index. That is, because the liquid lens 100 has high power, it can provide predetermined power with a smaller change in the curvature of the interface, thus requiring a smaller size. In addition, the liquid lens 100 can be used with a smaller change in the curvature of the interface so that it can operate at a lower voltage. This reduces the influence of noise on the image pickup device 303, thus allowing recording with high image quality.

The other members shown in FIG. 5, which are commonly used in digital cameras, will be briefly described.

A signal processing unit 504 performs analog signal processing. An analog-to-digital (A/D) converter 505 converts the analog signal to a digital signal. An image memory 506 stores the digital signal. An image processing unit 507 performs, for example, signal conversion and correction. A main central processing unit (CPU) 508 controls all operations of the digital camera. The CPU 508 executes a control program stored in a read-only memory (ROM) 509 to control, for example, the image processing unit 507 and the camera control unit 502. A random access memory (RAM) 510 provides a workspace for program execution. A video RAM (VRAM) 511 stores a captured image to be displayed on a pixel display unit 512. A compressing/decompressing unit 517 encodes the image information in the image memory 506. The encoded data is stored in a memory card 519 via an interface (I/F) 518.

The camera control unit 502 executes various operations based on a manipulating signal from a manipulating switch 513.

When a shutter switch 204 is pressed, the camera control unit 502 transmits a signal to a light control unit 515 to perform a predetermined operation such as firing a flash 203.

### Example 3

An example of an application of a liquid lens according to an embodiment of the present invention to an imaging lens of a camera-equipped cellular phone will be described.

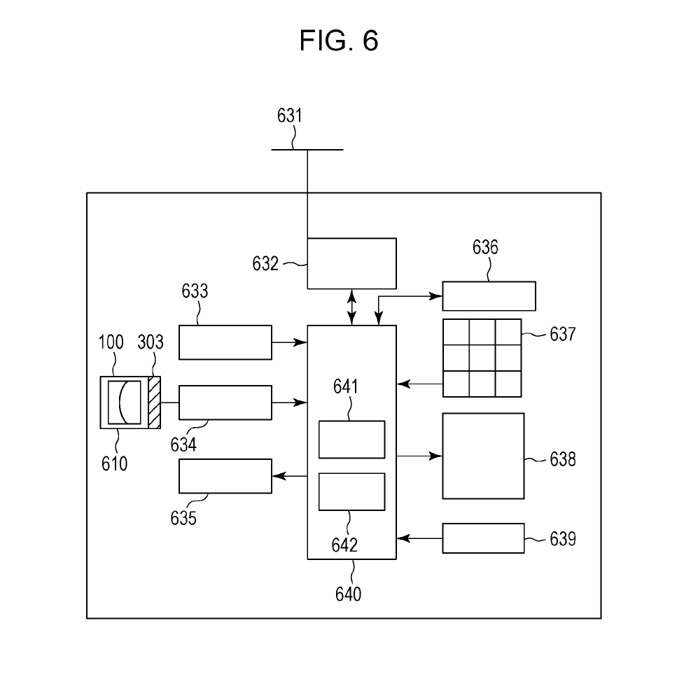

FIG. 6 is a schematic diagram of a relevant part of a cellular phone including a liquid lens according to an embodiment of the present invention.

A feature of the camera-equipped cellular phone shown in FIG. 6 is that it includes a camera 634 having an imaging lens unit 610 including a liquid lens 100 according to an embodiment of the present invention. This camera-equipped cellular phone is configured such that the position of the focal plane of an object to be imaged is adjusted to the position of an image pickup surface of an image pickup device 303 such as a CCD sensor.

The liquid lens 100, which can operate at low voltage and can be made compact, is advantageous for application to camera-equipped cellular phones because there is a demand for compact, lightweight cellular phones.

The other members shown in FIG. 6, which are commonly used in camera-equipped cellular phones, will be briefly described.

The cellular phone includes a control unit 640 including a CPU 641 and a ROM 642, an antenna 631 and a radio unit 632 connected to the control unit 640, a microphone 633, a receiver 635, an image storage unit 636 that stores an image captured by the camera 634, manipulating keys 637, a display 638 such as a liquid crystal display (LCD), and a shutter key 639 for shooting.

### Example 4

An example of an application of a liquid lens according to an embodiment of the present invention to a surveillance camera will be described.

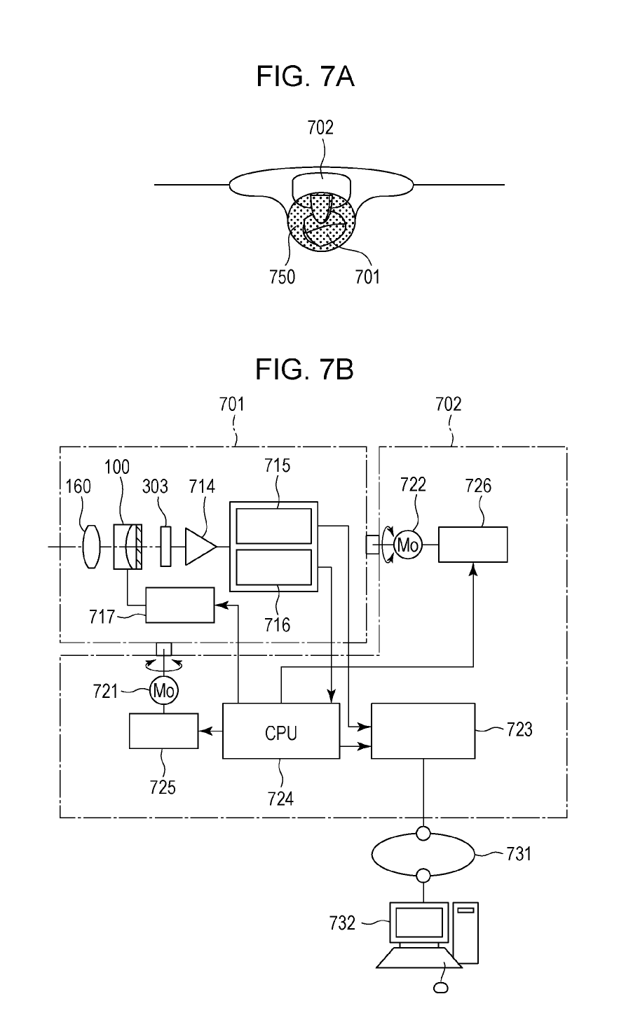

FIG. 7A is a schematic illustration showing the appearance of a surveillance camera including a liquid lens according to an embodiment of the present invention. FIG. 7B is a block diagram of a surveillance camera system.

In FIG. 7A, the surveillance camera includes a lens unit 701, a head unit 702, and a cover 750 covering the lens unit 701.

As shown in FIG. 7B, a feature of this example is that it incorporates a liquid lens 100 according to an embodiment of the present invention as one of the lenses of the lens unit 701. In FIG. 7B, a solid lens unit 160, the liquid lens 100, and an image pickup device 303 are arranged along an optical axis, and the output of the image pickup device 303 is connected to a video processing circuit 715 and a focus processing circuit 716 via an amplifier 714.

The head unit 702 includes a pan drive motor 721 and a tilt drive motor 722 that are configured to actuate the lens unit 701. The output of the video processing circuit 715 is connected to a network processing circuit 723 in the head unit 702. The output of the focus processing circuit 716 is connected to the CPU 724. The output of the CPU 724 is connected to an external local area network (LAN) 731 via the network processing circuit 723. The LAN 731 has a personal computer 732 connected thereto.

The output of the CPU 731 is also connected to the drive motors 721 and 722 via a pan drive circuit 725 and a tilt drive circuit 726, respectively, to supply a drive signal thereto.

In addition, the CPU 724 is connected to a liquid lens drive circuit 717. The liquid lens 100 is driven by the liquid lens drive circuit 717 for focus adjustment.

The security camera of this example can be made compact because the liquid lens 100 can be made compact.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-229655, filed Oct. 12, 2010, which is hereby incorporated by reference herein in its entirety.

### REFERENCE SIGNS LIST

100 liquid lens

101 cylindrical member

102, 103 lid

104 first liquid

105 second liquid

106 insulator

107 electrode

108 voltage source

1. A liquid lens comprising:
a liquid container;
an electrolytic solution contained in the container, the electrolytic solution containing iodide ions and a water-soluble antioxidant that inhibits oxidation of the iodide ions;
a nonelectrolytic solution contained in the container, the nonelectrolytic solution forming an interface with the electrolytic solution; and
an electrode configured to apply a voltage to the electrolytic solution;
wherein a voltage is applied across the electrolytic solution and the electrode to change the curvature of the interface.

2. The liquid lens according to claim 1, wherein the antioxidant has a standard redox potential of 0.53 V or less.

3. The liquid lens according to claim 2, wherein the antioxidant has a standard redox potential of 0.36 V or less.

4. The liquid lens according to claim 3, wherein the mass concentration of the antioxidant in the electrolytic solution is 0.0025% or more.

5. The liquid lens according to claim 4, wherein the mass concentration of the antioxidant in the electrolytic solution is 0.003% or more.

6. The liquid lens according to claim 4, wherein the iodide ions are produced by adding an iodide to a solvent used for the electrolytic solution, and the mass concentration of the iodide in the electrolytic solution is 50% or less.

7. The liquid lens according to claim 1, wherein the electrolytic solution has a specific gravity of 1.4 to 1.8.

8. The liquid lens according claim 1, wherein the antioxidant is one or more members selected from the group consisting of ascorbic acid, erythorbic acid, sodium erythorbate, glucose, lactic acid, malic acid, fumaric acid, ubiquinone, pyruvic acid, and carbonyl reductase.

9. A lens unit comprising the liquid lens according to claim 1 and a solid lens.

10. An image pickup apparatus comprising the liquid lens according to claim 1.

11. The image pickup apparatus according to claim 10, wherein the image pickup apparatus is a digital camera.

12. The image pickup apparatus according to claim 10, wherein the image pickup apparatus is a surveillance camera.

13. A camera-equipped cellular phone comprising the liquid lens according to claim 1.
